(19) United States
(12) Patent Application Publication
(10) Pub. No.: US 2021/0175825 A1
(43) Pub. Date: Jun. 10, 2021

(54) ELECTRIC MACHINE CONTROL SYSTEMS AND METHODS

(71) Applicant: Westinghouse Air Brake Technologies Corporation, Wilmerding, PA (US)

(72) Inventors: Carl L. Haas, Walkersville, MD (US); David Andrew Gloyd, Ellicott City, MD (US); Mark Uehling, Germantown, MD (US)

(21) Appl. No.: 17/078,848

(22) Filed: Oct. 23, 2020

Related U.S. Application Data
(60) Provisional application No. 62/943,894, filed on Dec. 5, 2019.

(51) Int. Cl. H02P 9/48; H02P 9/02

(52) U.S. Cl. CPC H02P 9/48; H02P 2101/15; H02P 9/02

(57) ABSTRACT

A system and method include monitoring an operating condition of an electric machine that converts rotational movement into an output voltage that is conducted into a circuit coupled with the electric machine, controlling operation of the electric machine using pulse width modulation signals, and changing a magnitude of the output voltage that is conducted into the circuit from the electric machine as a result of the pulse width modulation signals.

### CROSS-REFERENCE TO RELATED APPLICATIONS

This application claims priority to U.S. Provisional Application No. 62/943,894, filed 5 Dec. 2019, which is hereby incorporated by reference in its entirety.

### BACKGROUND

### Technical Field

The subject matter described herein relates to control systems for electric machines, such as turbines.

### Discussion Of Art

Rotary machines can be used to convert movement of a fluid into electric current. For example, the flow of air through a turbine can rotate turbine blades, which rotate a rotor of the turbine relative to a stator of the turbine. This rotation can be used to inductively transform electric current by converting the rotation or the rotor relative to the stator into the electric current.

The amount of electric current generated by the rotary machine can depend on characteristics of the flow at which the fluid moves through the rotary machine. Faster flow rates and/or greater fluid pressures can generate more current while slower rates and/or smaller fluid pressures can generate less current. Some rotary machines can be used in environments where the flow of a fluid through the rotary machine varies over time. For example, the rate and/or pressure at which air or other fluids flow through a turbine can change with respect to time. This can result in the rotary machines creating varying amounts of electric current. Additionally, the load placed on the rotary machines by one or more other devices (e.g., one or more electric loads) can change with respect to time and may not precisely coincide with the amount of current generated with respect to time.

For example, an air turbine provides a fixed input torque for a given flow of air through the turbine regardless of the opposing torque provided by a generator (having a rotor that is rotated by the turbine). While there is a load on the generator (e.g., the generator is supplying current to power a load), the generator generates torque that opposes rotation of the rotor in the turbine. But, when there is a reduced load on the generator, the generator may provide too small of an opposing torque. As a result, the turbine can overspeed (e.g., rapidly rotate), which can lead to increased wear and tear, and may result in premature failure of the system.

Some rotary machines are used in connection with resistors increase the opposing torque provided by the generator on the turbine. But, these resistors generate heat while current is generated by the generator and conducted to or through the resistors. This heat may need to be dissipated without interfering with or damaging other components of the system.

### BRIEF DESCRIPTION

One example method described herein includes monitoring an operating condition of an electric machine that converts rotational movement into an output voltage that is conducted into a circuit coupled with the electric machine, controlling operation of the electric machine using pulse width modulation signals, and changing a magnitude of the output voltage that is conducted into the circuit from the electric machine as a result of the pulse width modulation signals.

As an example, the magnitude of the output voltage is changed as the result of the pulse width modulation signals independent of one or more of a force applied to the electric machine and/or a load placed on the circuit.

In at least one embodiment, controlling the operation of the electric machine includes creating an additional magnetic field in the electric machine using the pulse width modulation signals that opposes a force applied to the electric machine.

In at least one embodiment, controlling the operation of the electric machine using the pulse width modulation signals transforms energy during each cycle of the pulse width modulation signals. The magnitude of the output voltage is changed by rectifying the energy that is transformed to increase the output voltage above a threshold voltage associated with a current operating speed of the electric machine.

As an example, the method also includes determining a change (such as an increase) in load demand of the circuit. The operation of the electric machine controlled using the pulse width modulation signals and the magnitude of the output voltage is changed responsive to the change (for example, an increase) in load demand being determined. In at least one embodiment, the increase in the load demand is determined based on sensor output from one or more of a voltage sensor of the circuit, a current sensor of the circuit, a speed sensor of the electric machine, or a force applied to the electric machine.

In at least one embodiment, controlling the operation of the electric machine includes shorting and/or increasing current in relation to two or more conductive coils of the electric machine together using the pulse width modulation signals. As an example, controlling the operation of the electric machine includes shorting the conductive coils together at a frequency of less than 100 kHz using the pulse width modulation signals. In at least one example, the shorting the two or more conductive coils regards increasing current in a generator by activating one or more transistors and/or other devices to allow additional current to flow in the generator without also allowing flow to the load.

Certain embodiments of the present disclosure provide a system that includes an electric machine configured to convert rotational movement of a rotor into an output voltage via coils that is conducted into a circuit coupled with the coils. A controller is configured to monitor an operating condition of the electric machine and to generate pulse width modulation signals that are conducted to switches operatively coupled with the coils of the electric machine. The pulse width modulation signals change states of the switches to short and/or increase current in relation to two or more of the coils with each other. The controller is configured to generate the pulse width modulation signals to change a magnitude of the output voltage that is conducted into the circuit from the electric machine.

As an example, the electric machine is a permanent magnet generator and the circuit is a rectifier circuit. The controller and the electric machine may be configured to be disposed onboard a vehicle for generating the output voltage to power one or more components of the vehicle. In at least one embodiment, the electric machine is a traction motor generating the output voltage via regenerative braking. In at least one other embodiment, the controller and the electric machine may be configured to be included in a stationary power-generating system.

As an example, the electric machine is an end-of-train generator. As another example, the electric machine is a wind turbine.

In at least one embodiment, the electric machine is a generator having a variable input force and/or a variable output load. The electric machine may be a generator that generates a reduced output voltage without the pulse width modulation signals relative to the output voltage that is generated using the pulse width modulation signals.

In at least one embodiment, the controller is configured to generate the pulse width modulation signals to change the magnitude of the output voltage independent a force applied to the electric machine and/or a load placed on the circuit.

As an example, the controller is configured to generate the pulse width modulation signals to increase the output voltage above a threshold voltage associated with a current operating speed of the electric machine.

In at least one embodiment, the system includes a sensor configured to detect a change (such as an increase) in load demand of the circuit. The controller is configured to generate the pulse width modulation signals responsive to the increase in load demand being detected by the sensor. As example, the sensor is one or more of a voltage sensor of the circuit, a current sensor of the circuit, a speed sensor of the electric machine, or a magnetic sensor that measures a force applied to the electric machine.

Certain embodiments of the present disclosure provide a vehicle including a generator configured to convert rotational movement of a rotor in the generator into an output voltage via conductive coils. A magnitude of the output voltage is based on a rotational speed of the rotor. A circuit having switches coupled with the coils of the generator is configured to receive the output voltage from the generator and to supply the output voltage to one or more vehicle devices for powering the vehicle devices. A controller is configured to monitor an operating condition of the generator and to generate pulse width modulation signals that are conducted to the switches of the circuit. The pulse width modulation signals change states of the switches to short and/or increase current in relation to two or more of the coils in the generator with each other. The controller is configured to generate the pulse width modulation signals to increase the output voltage that is conducted into the circuit from the generator above the magnitude that is a result of the rotational speed of the rotor.

### BRIEF DESCRIPTION OF THE DRAWINGS

The inventive subject matter may be understood from reading the following description of non-limiting embodiments, with reference to the attached drawings, wherein below:

FIG. 1 illustrates one example of a power generator system for a rotary machine;

FIG. 2 illustrates a circuit diagram of the control circuit shown in FIG. 1;

FIG. 3 illustrates examples of rotational speeds of the turbine shown in FIG. 1 as controlled by the control circuit also shown in FIG. 1;

FIG. 4 illustrates one example of an overspeed event of the turbine shown in FIG. 1; and

FIG. 5 illustrates a schematic block diagram of a system of monitoring an operating condition of an electric machine;

FIG. 6 illustrates a flow chart of a method of monitoring an operating condition of an electric machine.

### DETAILED DESCRIPTION

Embodiments of the subject matter described herein relate to systems and methods that control operation of an electric machine, such as rotary machine, by shorting outputs of the electric machine. These outputs can be coils of a generator. Movement of a stator of the generator relative to magnets (e.g., a rotor) of the generator generates electric current in the shorted coil(s). This current causes an opposing torque while the coil(s) are shorted. This opposing torque reduces the speed at which the generator (e.g., the rotor) rotates. While in this state, very little power is generated by the generator and the speed at which the generator operates is reduced (without generating significant amounts of heat). For example, less current than is needed to power a load coupled with the generator is produced without increasing the heat generated by the generator by more than 5%, by more than 10%, or by more than 15% in different embodiments. Different outputs of the generator can be shorted during different time periods, and two or more coils of the generator can be shorted during overlapping time periods.

The time periods and/or frequencies at which the coils are shorted can be controlled using control signals (e.g., pulse wave modulation, or PWM, signals). Changing the time periods and/or frequencies of the control signals can control the current output by the generator to match a load during times that the fluid flow through the generator is varying with respect to time and/or the load is varying with respect to time. This can prevent overspeed of the generator and increase the useful life span of the generator.

Additionally, certain embodiments of the present disclosure are configured to manage generator power over a range of input air pressures to the turbine. When the air pressure provided to the turbine various significantly, the output power of the generator also varies significantly. If the air turbine is sized and configured to provide power at relatively low air pressure, the power provided to the generator may be excessive at higher air pressures, which may result in excessive generator and turbine speeds, even with a fixed load. As such, embodiments of the present disclosure provide systems and methods that are configured to control turbine and generator speed, even when air pressure and load are varied.

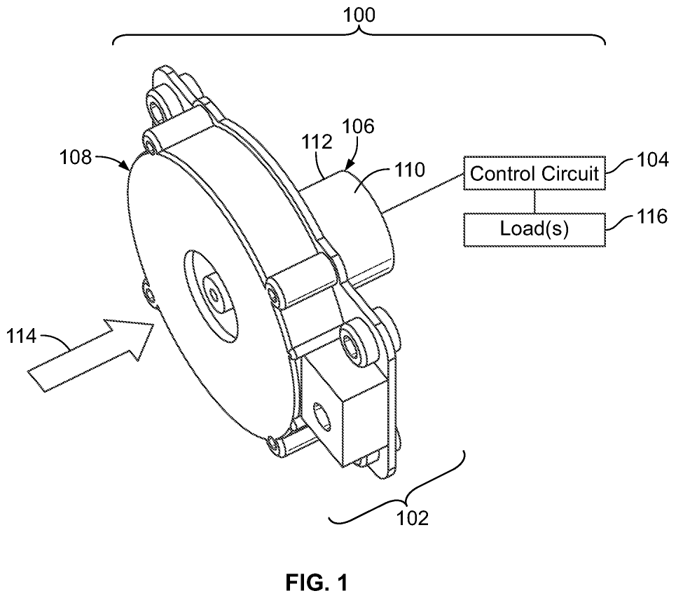

FIG. 1 illustrates one example of a power generator system 100 for a rotary machine 102. The system includes a control circuit 104 that is coupled with the rotary machine. The control circuit controls operation of the rotary machine, as described herein. The rotary machine can include a generator 106 coupled with a turbine 108. The generator can represent a device that converts rotary movement into electric current, such as an induction generator, an alternator, or the like. The generator includes a rotor 110 that rotates relative to a stator 112. The rotor can include one or more magnets that induce current in conductive coils (not shown in FIG. 1) of the stator during rotation of the magnets relative to the coils.

Fluid 114 flows through the turbine to rotate the rotor, such as by rotating blades coupled with the rotor. In one example, the fluid is air. Optionally, the fluid can be another gas (e.g., engine exhaust, air mixed with engine exhaust, steam, or another type of gas) and/or a liquid (e.g., water, a lubricant such as oil, etc.). The generator inductively generates electric current from rotation of the turbine, which can be supplied to one or more electric loads 116. These loads can represent propulsion devices of a vehicle (e.g., motors), monitoring devices (e.g., sensors), communication devices, auxiliary devices, hand-held power tools, or the like.

The control circuit can short and/or increase current in relation to one or more coils of the generator using control signals. The control signals dictate duty cycles by which the coils are shorted or not shorted. For example, the control signals can direct the time periods and/or frequencies during which a switch coupled to a coil closes to short the coil. Different control signals can be communicated to different switches to close or open the switches at different time durations (e.g., time periods) and/or at different frequencies. These control signals can be pulse width modulation (PWM) signals in one example. Optionally, instead of shorting the outputs, the control signals can be used to alternate between coupling the outputs with the load(s), with another output of the rotary machine, and/or with another device or location.

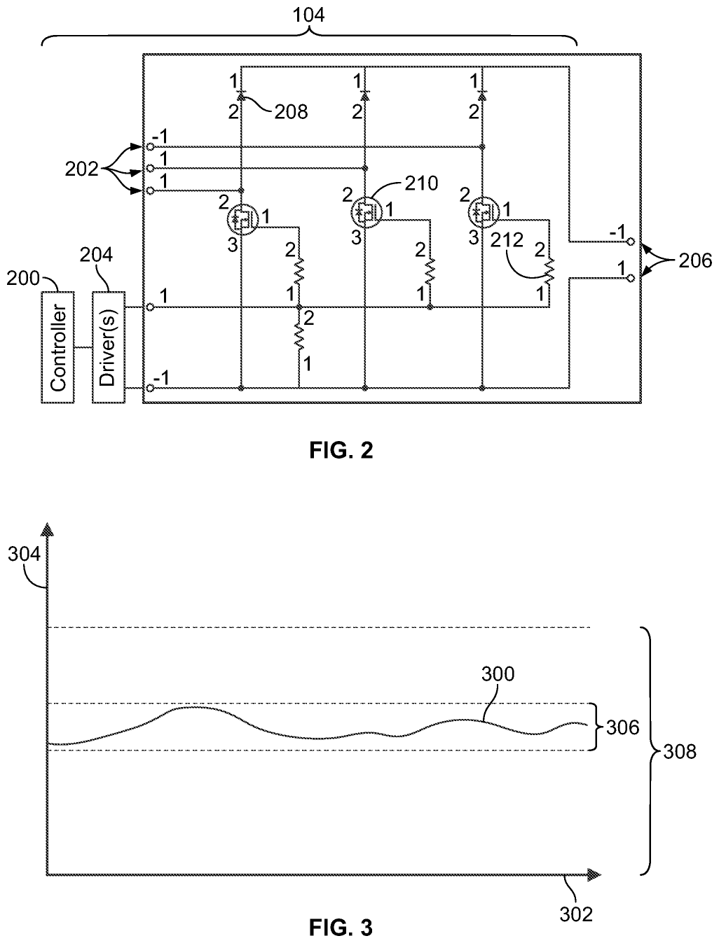

FIG. 2 illustrates a circuit diagram of the control circuit shown in FIG. 1. The control circuit includes a controller 200 that represents hardware circuitry that includes and/or is connected with one or more processors (e.g., one or more microprocessors, field programmable gate arrays, integrated circuits, etc.). The controller is conductively coupled with several outputs 202 (e.g., outputs 202A-C) of the generator shown in FIG. 1 via one or more drivers 204. These outputs can represent coils of the generator and/or connections to the coils. For example, the outputs can represent the different coils through which different phases of the current produced by the generator are output to the control circuit. The current generated by the generator is induced in one or more of the coils and is conducted to terminals or connectors 206 coupled with the loads via the control circuit (as shown in FIG. 2).

The control circuit includes diodes 208 that are conductively coupled with the outputs of the generator. Each diode is connected with a single, different output than the other diodes in the illustrated example. For example, each output can be coupled with the terminals or connectors of the load(s) by a different diode. The control circuit also includes switches 210 that are conductively coupled with the outputs of the generator. The switches 210 can represent field effect transistors, insulated gate bipolar transistors, or the like. As shown, each switch can be connected with a single, different output than the other switches. For example, each output of the generator is coupled with a different line in the control circuit in a location that is between a different diode (than the other generator outputs) and a different switch (than the other generator outputs). Each output can be connected in a location between the emitter or drain of the switch and the anode of the diode, as shown in FIG. 2. The cathode of each diode can be connected with one of the terminals connected with the load(s) (e.g., the positive terminal). The collector or source of each switch can be connected with another terminal of the load(s) (e.g., the negative terminal). The driver(s) are connected with gates of the switches. One or more resistive elements (e.g., resistors) 212 may be placed between the driver(s) and the gates of each of the switches. While three outputs, coils, diodes, and switches are shown to represent the generator creating a three-phase current for the load(s), optionally, the generator may have a single output, single coil, single diode, and/or single switch; two outputs, two coils, two diodes, and/or two switches; or more than three outputs, more than three coils, more than three diodes, and/or more than three switches.

The one or more drivers control application of control signals to the switches. These control signals cause or direct the switches to open or close. For example, the drivers can represent one or more gate drives that apply voltages to gates of the switches to activate (or close) the switches. Application of the signal to a switch can cause the switch to close and short the corresponding output of the generator. Removal of the signal from the switch can cause the switch to open (or deactivate) and reconnect the corresponding output with the load(s).

In operation, the driver(s) apply the control signals as PWM signals to control the speed at which the turbine rotates. The driver(s) can apply the PWM signals to the switches to keep the rotational speed of the turbine at a designated value or within a designated range of values (that is smaller than the maximum or rated range of rotational speeds of the turbine), even when the rate and/or pressure of the fluid flowing through the turbine changes. For example, the driver(s) can apply the PWM signals to keep the rotational speed of the turbine substantially the same (e.g., does not vary by more than 1%, by more than 3%, or by more than 5% in different embodiments) and/or to keep the rotational speed of the turbine within a defined window or range of speeds, even while the flow rate and/or pressure of the fluid flowing through the turbine changes (e.g., changes by more than 5%, by more than 10%, etc.). Additionally or alternatively, the driver(s) can apply the PWM signals to keep the rotational speed of the turbine substantially the same and/or to keep the rotational speed of the turbine within a defined window or range of speeds, even while the load placed on the generator by the load(s) changes (e.g., changes by more than 5%, by more than 10%, etc.).

Closing a switch causes a portion (e.g., phase) of the electric current conducted out of the outlet connected with the closed switch to be conducted into the control circuit, and not to the load(s). For example, closing a switch can cause the current conducted out of the outlet coupled with that switch to be conducted to the ground reference or to another outlet. In the illustrated example, a closed switch connects the coupled outlet with the other outlets. Alternatively, the drains of the switches shown in FIG. 2 can be connected with a ground reference to direct the current from an outlet connected with a closed switch to the ground reference.

Closing a switch induces a temporary magnetic field in the rotary machine that resists a force imparted on the rotor of the rotary machine by the fluid. For example, applying a control signal to close one (but not all) of the switches induces a reverse magnetic field that opposes rotation of the turbine in the direction of rotation caused by flow of the fluid. Closing more switches can increase the magnitude of this opposing magnetic field. Closing a switch for longer (e.g., increasing a duty cycle time, or time period) can cause the induced magnetic field to be applied for longer.

The controller can determine the speed at which the turbine is rotating and control the driver(s) to create the control signals based on the speed that is determined. As one example, the controller can detect the electric current generated by the rotary machine via the generator. The controller can be coupled with one or more voltage or current sensors 214 to sample or otherwise measure the current(s) conducted out of one or more of the outlets. Based on the measured current, the controller can determine whether the speed of the turbine is increasing or decreasing, is faster than a threshold, or is slower than a threshold. For example, if the generated current is increasing, the controller can determine that rotation of the turbine is speeding up. If the generated current is decreasing, the controller can determine that rotation of the turbine is slowing down. If the generated current exceeds a threshold, the controller can determine that rotation of the turbine is faster than a speed associated with or represented by the threshold. This threshold can be empirically determined. If the generated current does not exceed the threshold, the controller can determine that rotation of the turbine is slower than the speed associated with or represented by the threshold. Optionally, one or more speed sensors may report the speed of the turbine to the controller.

The controller can monitor the pressure of the fluid flowing through the turbine in a similar manner. For example, the controller can detect the electric current generated by the rotary machine via the generator. Based on the measured current, the controller can determine whether the pressure of the fluid is increasing or decreasing, is greater than a threshold, or is less than a threshold. For example, if the generated current is increasing, the controller can determine that the fluid pressure is increasing. If the generated current is decreasing, the controller can determine that the fluid pressure is decreasing. If the generated current exceeds a threshold, the controller can determine that the fluid pressure is greater than a threshold pressure. This threshold can be empirically determined. If the generated current does not exceed the threshold, the controller can determine that the fluid pressure is less than the threshold pressure. Optionally, one or more pressure sensors may report the pressure of the fluid to the controller.

The controller can monitor the load placed on the generator by the load(s) by monitoring operation of the load(s). For example, the load(s) can communicate the demanded electric current to the controller. Optionally, the controller can communicate with the loads to monitor operation of the load(s) to determine changes in how many loads are operating (and therefore need current), the operational state of the loads (e.g., whether the loads are in standby mode or actively operating), etc.

The controller can direct the driver(s) to generate or change the control signals (e.g., the PWM signals) based on the rotational speed of the turbine that is determined. For example, responsive to the speed increasing or increasing above a threshold, the controller can direct the driver(s) to generate control signals that close one or more switches. The switch(es) can be closed for the same or different time periods (e.g., duty cycles) and/or alternated between open and closed states at the same or different frequencies. The time periods and/or frequencies dictated by the control signals can be based on the speed that is determined. For example, for greater decreases in the rotational speed of the turbine, the controller may direct the driver(s) to generate the PWM signals to have more switches closed or activated, to have one or more switches closed or activated for longer, and/or to have one or more switches alternate between closed and open states at a faster frequency than for slower speeds of the turbine.

As the speed of the turbine changes, the controller can change the PWM signals. For example, responsive to the turbine increasing rotational speed and/or the controller determining that the turbine speed is to be decreased, the controller can increase the number of switches that are closed, lengthen the duty cycle over which one or more switches are closed, and/or increase the frequency at which one or more switches alternate between closed and open states. As another example, responsive to the turbine decreasing rotational speed and/or the controller determining that the turbine speed is to be increased, the controller can decrease the number of switches that are closed, shorten the duty cycle over which one or more switches are closed, and/or decrease the frequency at which one or more switches alternate between closed and open states.

FIG. 3 illustrates examples of rotational speeds 300 of the turbine shown in FIG. 1 as controlled by the control circuit also shown in FIG. 1. The rotational speeds are shown alongside a horizontal axis 302 representative of time and a vertical axis 304 representative of how fast the turbine is rotating. As shown, the rotational speeds of the turbine change over time due to changes in the fluid flowing through the turbine. The control circuitry directs generation of the PWM signals to keep the speed of the turbine within a defined window 306 of speeds. This defined window can keep the turbine and generator creating electric current within a defined range of magnitudes even if the rate and/or pressure of fluid flow through the turbine changes. Additionally, this defined window can be smaller (e.g., extend over a smaller range of speeds) than an entire operational range 308 of the turbine. The operational range can represent the range of speeds that the turbine is designed or manufactured to operate within before failure is likely. Controlling the turbine to operate within the defined window may prevent the turbine from rotating at speeds approaching the upper or maximum limit on the turbine. This can extend the useful life of the turbine.

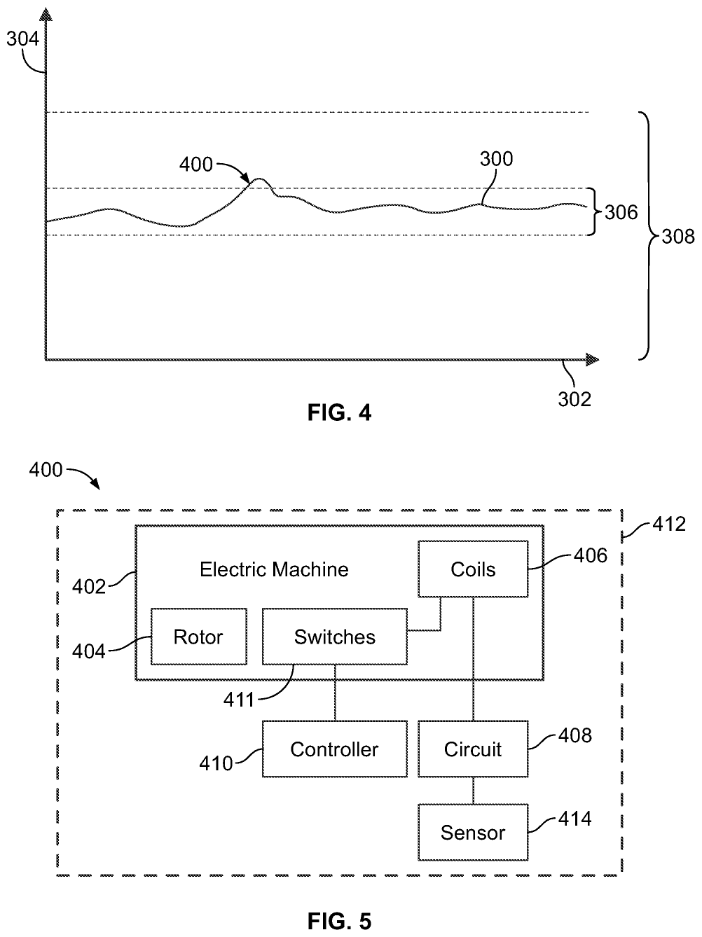

FIG. 4 illustrates one example of an overspeed event 400 of the turbine shown in FIG. 1. The rotational speed of the turbine may speed up and exceed the upper limit of the defined window. This may occur when the fluid flow rate and/or pressure suddenly and/or unexpectedly increases before the controller can detect the increase in speed and direct the driver(s) to generate the PWM signals to reduce the turbine speed. Responsive to detecting that the speed of the turbine exceeds a threshold (e.g., the upper limit of the defined window), the controller can direct the driver(s) to change or begin creating the PWM signals to slow down the turbine speed to within the defined window, as described herein.

In one embodiment, the rotary machine shown in FIG. 1 may be disposed onboard a vehicle system. For example, the power generator system may be onboard a rail vehicle, automobile, truck, marine vessel, aircraft (manned, unmanned, or drone), agricultural vehicle, mining vehicle, or one or more other off-highway vehicles, to power one or more loads of the vehicle. With resect to rail vehicles, the power generator system can be used to power an end-of-train device onboard a rail vehicle system (e.g., a train). This end-of-train device can include sensors and communication devices to monitor brake pipe pressure, location, speed, etc., and communicate this information to other devices onboard the same vehicle system (e.g., an engine control unit of the rail vehicle system, an off-board location such as a back office system or server, etc.). These sensors and/or communication devices can be at least partially powered by the power generator system.

The turbine shown in FIG. 1 may represent or be replaced by a propeller, such as a propeller of a marine vessel. The generator shown in FIG. 1 may represent or be replaced by a motor that is coupled with the propeller. The controller can direct the drive(s) to generate and conduct the PWM signals the control circuitry. These signals short out the coils of the motor, as described above in connection with the generator. This allows for the controller to control the speed at which the propeller rotates. For example, the controller can short out different coils of the motor in response to changing flow of water through the propeller. This can allow the controller to control the propeller speed to within a designated range even during movement through fast moving water. Optionally, the turbine shown in FIG. 1 may be placed into a conduit through which the fluid flows, such as a conduit through which oil, coolant, or the like, flows within a vehicle or other powered system.

When used in connection with a vehicle, the power generator system optionally can be referred to as a vehicle control system. For example, the rotary machine can include a traction motor as the generator and the turbine shown in FIG. 1 can be replaced by a wheel or axle that is connected with and rotated by the traction motor. During movement, the controller can determine (e.g., autonomously and/or based on operator input) to slow the vehicle. The controller can direct the traction motor to generate a braking effort on the wheel or axle similar to slowing rotation of the turbine in response to increasing rotation speeds, as described above. For example, the controller can direct the drive(s) to send PWM signals to the switches to induce temporary magnetic fields that resist rotation of the wheel or axle. This can brake and slow the vehicle similar to how the magnetic field slows rotation of the turbine in the power generator system.

With respect to aircraft, the turbine shown in FIG. 1 can be a turbine engine onboard an aircraft. The controller can control application of the PWM signals to control propulsion of the aircraft. For example, to slow propulsion of the aircraft (e.g., during landing), the controller can direct the PWM signals to be applied to generate the temporary magnetic fields and slow rotation of the blades or airfoils in the turbine engine, even though the air may be moving through the turbine engine at fast speeds. This can slow rotation of the blades to help reduce propulsion and slow movement of the aircraft. Optionally, the controller can direct application of the PWM signals such that the speed at which the turbine blades rotate remains the same or within a designated range of speeds even during varying flow conditions of the wind through the turbine engine.

The power generator system optionally can be used with a wind turbine. For example, the turbine shown in FIG. 1 can be a wind turbine that generates electric current by rotating the rotor of the generator also shown in FIG. 1. The controller can dictate generation of the PWM signals to prevent and/or reduce the duration of overspeed events of the wind turbine. This can decrease wear and tear on components of the wind turbine. Additionally, controlling the speed at which the wind turbine is allowed to rotate using the PWM signals can extend the range of operating speeds that the wind turbine can operate without having to change gearing or an orientation of blades of the wind turbine.

FIG. 5 illustrates a schematic block diagram of a system 400 of monitoring an operating condition of an electric machine 402, such as a rotary machine as shown in FIG. 1. The electric machine is configured to convert rotational movement of a rotor 404 (such as shown and described in FIG. 1) into an output voltage via one or more coils 406 that is conducted into a circuit 408 coupled with the coils. The electric machine may include the circuit. Optionally, the circuit may be separate and distinct from the electric machine. In at least one embodiment, the circuit may not include a DC-DC converter. In at least one embodiment, the electric machine includes the rotor and/or the coil(s). The system may include two, three, or more coils, for example.

A controller 410 (such as shown and described in FIG. 2) monitors an operating condition of the electric machine and generates pulse width modulation (PWM) signals that are conducted to switches 411 operatively coupled with the coils of the electric machine. In at least one embodiment, the circuit includes the switches. Optionally, the switches may be distinct from the circuit. The circuit may include the controller. Optionally, the controller may be separate and distinct from the controller. The system may include two or more switches that are operatively coupled with the coils. The pulse width modulation signals change states of the switches to short two or more of the coils with each other. The controller generates the pulse width modulation signals to change a magnitude of the output voltage that is conducted into the circuit from the electric machine.

In at least one embodiment, the electric machine is a permanent magnet generator. In this embodiment, the circuit is a rectifier circuit. Optionally, the electric machine may be other than a permanent magnet generator, and the circuit may be other than a rectifier circuit.

In at least one embodiment, the controller and the electric machine are configured to be disposed onboard a vehicle 412 for generating the output voltage to power one or more components of the vehicle. Examples of the vehicle include a rail vehicle, an automobile, a truck, a marine vessel, an aircraft (manned, unmanned, or drone), an agricultural vehicle, a mining vehicle, or one or more other off-highway vehicles. With respect to rail vehicles, the controller and the electric machine can be used to power a component, such as an end-of-train device onboard a rail vehicle system (e.g., a train). In at least one embodiment, the electric machine is the end-of-train device, such as an end-of-train generator. This end-of-train device can include sensors and communication devices to monitor brake pipe pressure, location, speed, etc., and communicate this information to other devices onboard the same vehicle system (e.g., an engine control unit of the rail vehicle system, an off-board location such as a back office system or server, etc.).

As another example, the electric machine is a traction motor generating the output voltage via regenerative braking. The controller can direct the traction motor to generate a braking effort on the wheel or axle similar to slowing rotation of the turbine in response to increasing rotation speeds. For example, the controller can direct the drive(s) to send PWM signals to the switches to induce temporary magnetic fields that resist rotation of the wheel or axle. This can brake and slow the vehicle similar to how a magnetic field slows rotation of a turbine. In general, the electric machine may be a traction motor of the vehicle, and the controller can generate a braking effort of the vehicle by applying the PWM signals to resist rotation of the traction motor.

As another example, instead of being within a vehicle, the controller and the electric machine may be included in a stationary power-generating system. For example, the vehicle shown in FIG. 4 may optionally be a stationary power-generating system, such as found in an electric power plant.

As noted, the electric machine may be an end-of-train generator. As another example, the electric machine may be a wind turbine.

In at least one embodiment, the electric machine is a generator having a variable input force and/or a variable output load. In at least one embodiment, the electric machine is a generator that generates a reduced output voltage without the pulse width modulation signals relative to the output voltage that is generated using the pulse width modulation signals.

In at least one embodiment, the controller is configured to generate the pulse width modulation signals to change the magnitude of the output voltage independent of a force applied to the electric machine and/or a load placed on the circuit. In at least one embodiment, the controller is configured to generate the pulse width modulation signals to increase the output voltage above a threshold voltage associated with a current operating speed (e.g., of the rotor) of the electric machine.

In at least one embodiment, the system also includes a sensor 414 in communication with the circuit and/or the controller, such as through one or more wired or wireless connections. The sensor is configured to detect a change (such as an increase) in load demand of the circuit. The controller is configured to generate the pulse width modulation signals responsive to the increase in load demand detected by the sensor. The sensor may be a sensor that is configured to detect voltage or current, for example. For example, the sensor may be a voltage sensor of the circuit, a current sensor of the circuit, a speed sensor of the electric machine (such as detects revolutions per minute of the rotor), and/or a magnetic sensor that measures a force applied to the electric machine.

Certain embodiments of the present disclosure provide a vehicle including an electric machine, such as a generator configured to convert rotational movement of a rotor in the generator into an output voltage via conductive coils. A magnitude of the output voltage is based on a rotational speed of the rotor. A circuit having switches is coupled with the coils of the generator. The circuit is configured to receive the output voltage from the generator and to supply the output voltage to one or more vehicle devices for powering the vehicle devices. The vehicle devices may include one or more engines, braking systems, electronic systems, and/or the like. A controller is configured to monitor an operating condition of the generator and to generate pulse width modulation signals that are conducted to the switches of the circuit. The pulse width modulation signals change states of the switches to short two or more of the coils in the generator with each other. The short induces a magnetic field in the electric machine. The induced magnetic field changes the voltage output of the electric machine. The change in voltage is an increase in the voltage output. The controller is configured to generate the pulse width modulation signals to increase the output voltage that is conducted into the circuit from the generator above the magnitude that is a result of the rotational speed of the rotor.

Certain embodiments of the present disclosure are configured to provide electrical power to an end-of-train device, and control an operating speed of a microturbine. Embodiments of the present disclosure provide systems and methods that may replace boost converter circuitry (or other power electronics that provide a voltage boost) through use of a controller that controls operation of an electric machine using pulse width modulation signals.

Current flows in a loop. As such, in at least one embodiment, to short a coil, winding, phase, or the like, two switches may be activated to electrically connect terminals together. Because the shorted path has less resistance than the rest of the circuitry, additional current flows in the coil or coils and the shorted path, but not to the load while the switches are active. In at least one embodiment, activating two or more switches electrically connects shorted terminals to ground, thereby also shorting the terminals to each other. In at least one example, one or more of the switches may be transistor-based. Diodes may be discrete or integrated within the transistor. Each switch may be separately controlled if also used for a motor application in which power flows in an opposite direction.

In at least one embodiment, control is achieved by shorting all phase terminals together to a low side (ground) simultaneously. In at least one embodiment, at a given point in generator rotation there is a dominant phase (pair of terminals) that has the greatest output potential. In such an embodiment, the control system shorts the dominant phase or pair of terminals.

In at least one embodiment, if a separate switch device is placed across each potential phase pair, then a single switch activation may induce additional current without a diode power loss penalty.

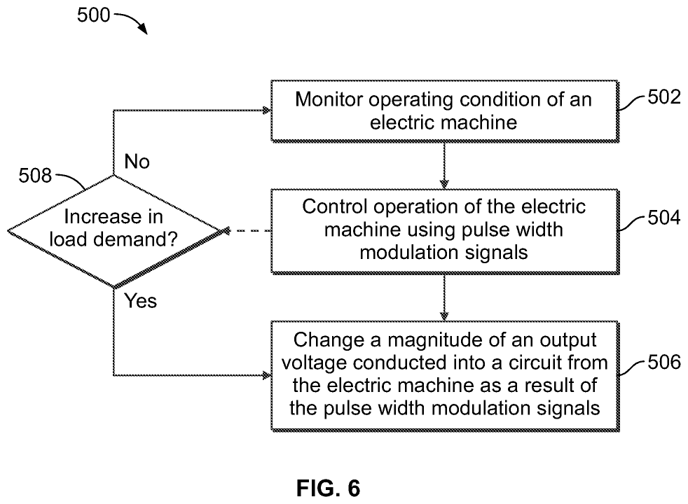

FIG. 6 illustrates a flow chart of a method 500 of monitoring an operating condition of an electric machine. The method 500 can represent operations performed by the control circuit and/or controller described herein to control the speed at which the rotary machine rotates.

At 502, an operating condition of an electric machine is monitored. The electric machine converts rotational movement into an output voltage that is conducted into a circuit coupled with the electric machine. For example, the controller (shown and described with respect to FIG. 4) monitors the operating condition of the electric machine.

At 504, operation of the electric machine is controlled using pulse width modulation signals. For example, the controller may control operation of the electric machine using the pulse width modulation signals.

At 506, a magnitude of the output voltage that is conducted into the circuit from the electric machine is changed as a result of (for example, in response to) the pulse width modulation signals. That is, the magnitude of the output voltage is changed due to the pulse width modulation signals. As an example, an increase in voltage is caused by (that is, a result of) the pulse width modulation signals. The controller may change the output voltage conducted into the circuit as a result of the pulse width modulation signals. The method then returns to the monitoring.

In at least one embodiment, the magnitude of the output voltage is changed as the result of the pulse width modulation signals independent of a force applied to the electric machine and/or a load placed on the circuit.

The controlling the operation of the electric machine may include creating an additional magnetic field in the electric machine using the pulse width modulation signals that opposes a force applied to the electric machine. In at least one embodiment, the controlling the operation of the electric machine using the pulse width modulation signals transforms energy during each cycle of the pulse width modulation signals. The magnitude of the output voltage is changed by rectifying the energy that is transformed to increase the output voltage above a threshold voltage associated with a current operating speed of the electric machine.

Optionally, the method may include determining 508, such as by the controller, a change (such as an increase) in load demand of the circuit. If there is not an increase in load demand, the method returns to the monitoring. If, however, there is an increase in load demand, the method proceeds to the changing the magnitude. For example, the operation of the electric machine controlled using the pulse width modulation signals and the magnitude of the output voltage changed is responsive to the increase in load demand being determined. In at least one embodiment, the increase in the load demand is determined based on sensor output from one or more of a voltage sensor of the circuit, a current sensor of the circuit, a speed sensor of the electric machine, or a force applied to the electric machine.

In at least one embodiment, the controlling the operation of the electric machine includes shorting two or more conductive coils of the electric machine together using the pulse width modulation signals. For example, the controlling the operation of the electric machine includes shorting the conductive coils together at a frequency of less than 100 kHz using the pulse width modulation signals. For example, the frequency may be less than 50 kHz. Alternatively, the frequency may exceed 100 kHz, such as 200 kHz. In at least one example, the shorting the two or more conductive coils regards increasing current in a generator by activating one or more transistors and/or other devices to allow additional current to flow in the generator without also allowing flow to the load.

As used herein, the terms “processor” and “computer,” and related terms, e.g., “processing device,” “computing device,” and “controller” may be not limited to just those integrated circuits referred to in the art as a computer, but refer to a microcontroller, a microcomputer, a programmable logic controller (PLC), field programmable gate array, and application specific integrated circuit, and other programmable circuits. Suitable memory may include, for example, a computer-readable medium. A computer-readable medium may be, for example, a random-access memory (RAM), a computer-readable non-volatile medium, such as a flash memory. The term “non-transitory computer-readable media” represents a tangible computer-based device implemented for short-term and long-term storage of information, such as, computer-readable instructions, data structures, program modules and sub-modules, or other data in any device. Therefore, the methods described herein may be encoded as executable instructions embodied in a tangible, non-transitory, computer-readable medium, including, without limitation, a storage device and/or a memory device. Such instructions, when executed by a processor, cause the processor to perform at least a portion of the methods described herein. As such, the term includes tangible, computer-readable media, including, without limitation, non-transitory computer storage devices, including without limitation, volatile and non-volatile media, and removable and non-removable media such as firmware, physical and virtual storage, CD-ROMS, DVDs, and other digital sources, such as a network or the Internet.

The singular forms “a”, “an”, and “the” include plural references unless the context clearly dictates otherwise. “Optional” or “optionally” means that the subsequently described event or circumstance may or may not occur, and that the description may include instances where the event occurs and instances where it does not. Approximating language, as used herein throughout the specification and claims, may be applied to modify any quantitative representation that could permissibly vary without resulting in a change in the basic function to which it may be related. Accordingly, a value modified by a term or terms, such as “about,” “substantially,” and “approximately,” may be not to be limited to the precise value specified. In at least some instances, the approximating language may correspond to the precision of an instrument for measuring the value. Here and throughout the specification and claims, range limitations may be combined and/or interchanged, such ranges may be identified and include all the sub-ranges contained therein unless context or language indicates otherwise.

This written description uses examples to disclose the embodiments, including the best mode, and to enable a person of ordinary skill in the art to practice the embodiments, including making and using any devices or systems and performing any incorporated methods. The claims define the patentable scope of the disclosure, and include other examples that occur to those of ordinary skill in the art. Such other examples are intended to be within the scope of the claims if they have structural elements that do not differ from the literal language of the claims, or if they include equivalent structural elements with insubstantial differences from the literal language of the claims.

What is claimed is:

1. A method comprising:
monitoring an operating condition of an electric machine that converts rotational movement into an output voltage that is conducted into a circuit coupled with the electric machine;
controlling operation of the electric machine using pulse width modulation signals; and
changing a magnitude of the output voltage that is conducted into the circuit from the electric machine as a result of the pulse width modulation signals.

2. The method of claim 1, wherein the magnitude of the output voltage is changed as the result of the pulse width modulation signals independent of one or more of:
a force applied to the electric machine or a load placed on the circuit.

3. The method of claim 1, wherein controlling the operation of the electric machine includes creating an additional magnetic field in the electric machine using the pulse width modulation signals that opposes a force applied to the electric machine.

4. The method of claim 1, wherein controlling the operation of the electric machine using the pulse width modulation signals transforms energy during each cycle of the pulse width modulation signals, the magnitude of the output voltage changed by rectifying the energy that is transformed to increase the output voltage above a threshold voltage associated with a current operating speed of the electric machine.

5. The method of claim 1, further comprising:
determining a change in load demand of the circuit, the operation of the electric machine controlled using the pulse width modulation signals and the magnitude of the output voltage changed responsive to the change in load demand being determined.

6. The method of claim 5, wherein the increase in the load demand is determined based on sensor output from one or more of a voltage sensor of the circuit, a current sensor of the circuit, a speed sensor of the electric machine, or a force applied to the electric machine.

7. The method of claim 1, wherein controlling the operation of the electric machine includes shorting two or more conductive coils of the electric machine together using the pulse width modulation signals.

8. The method of claim 7, wherein controlling the operation of the electric machine includes shorting the conductive coils together at a frequency of less than 100 kHz using the pulse width modulation signals.

9. A system comprising:
an electric machine configured to convert rotational movement of a rotor into an output voltage via coils that is conducted into a circuit coupled with the coils; and
a controller configured to monitor an operating condition of the electric machine and to generate pulse width modulation signals that are conducted to switches operatively coupled with the coils of the electric machine, the pulse width modulation signals changing states of the switches to short two or more of the coils with each other,
wherein the controller is configured to generate the pulse width modulation signals to change a magnitude of the output voltage that is conducted into the circuit from the electric machine.

10. The system of claim 9, wherein the electric machine is a permanent magnet generator and the circuit is a rectifier circuit.

11. The system of claim 9, wherein the controller and the electric machine are configured to be disposed onboard a vehicle for generating the output voltage to power one or more components of the vehicle.

12. The system of claim 11, wherein the electric machine is a traction motor generating the output voltage via regenerative braking.

13. The system of claim 9, wherein the controller and the electric machine are configured to be included in a stationary power-generating system.

14. The system of claim 9, wherein the electric machine is an end-of-train generator.

15. The system of claim 9, wherein the electric machine is a wind turbine.

16. The system of claim 9, wherein the electric machine is a generator having one or more of: a variable input force or a variable output load.

17. The system of claim 9, wherein the electric machine is a generator that generates a reduced output voltage without the pulse width modulation signals relative to the output voltage that is generated using the pulse width modulation signals.

18. The system of claim 9, wherein the controller is configured to generate the pulse width modulation signals to change the magnitude of the output voltage independent of one or more of: a force applied to the electric machine or a load placed on the circuit.

19. The system of claim 9, wherein the controller is configured to generate the pulse width modulation signals to increase the output voltage above a threshold voltage associated with a current operating speed of the electric machine.

20. The system of claim 9, further comprising:
a sensor configured to detect a change in load demand of the circuit, the controller configured to generate the pulse width modulation signals responsive to the change in load demand being detected by the sensor.

21. The system of claim 20, wherein the sensor is one or more of a voltage sensor of the circuit, a current sensor of the circuit, a speed sensor of the electric machine, or a magnetic sensor that measures a force applied to the electric machine.

22. A vehicle comprising:
a generator configured to convert rotational movement of a rotor in the generator into an output voltage via conductive coils, wherein a magnitude of the output voltage is based on a rotational speed of the rotor;
a circuit having switches coupled with the coils of the generator, the circuit configured to receive the output voltage from the generator and to supply the output voltage to one or more vehicle devices for powering the vehicle devices; and
a controller configured to monitor an operating condition of the generator and to generate pulse width modulation signals that are conducted to the switches of the circuit, the pulse width modulation signals changing states of the switches to short two or more of the coils in the generator with each other,
wherein the controller is configured to generate the pulse width modulation signals to increase the output voltage that is conducted into the circuit from the generator above the magnitude that is a result of the rotational speed of the rotor.
